(19) United States
(12) Patent Application Publication
(10) Pub. No.: US 2015/0242753 A1
(43) Pub. Date: Aug. 27, 2015

(54) AUTOMATED MANAGEMENT OF USER ACTIVITY LISTS

(71) Applicants: Annapurna Yarlagadda, Milpitas, CA (US); Kiran Kumar Gunnam, Milpitas, CA (US); Paul Budnik, Los Gatos, CA (US)

(72) Inventors: Annapurna Yarlagadda, Milpitas, CA (US); Kiran Kumar Gunnam, Milpitas, CA (US); Paul Budnik, Los Gatos, CA (US)

(73) Assignee: SmartChiq Inc., Milpitas, CA (US)

(21) Appl. No.: 14/628,295

(22) Filed: Feb. 22, 2015

Related U.S. Application Data
(60) Provisional application No. 61/943,440, filed on Feb. 23, 2014.
(60) Provisional application No. 61/972,223, filed on Mar. 29, 2014.

(51) Int. Cl. G06N 5/04; G06Q 30/06

(52) U.S. Cl. CPC G06N 5/04; G06Q 30/0631; G06Q 30/0633

(57) ABSTRACT

Embodiments of the present invention are iterative methods that: 1) analyze data from one or more electronic data-sources so as to a) identify or generate an activity (“proposed activity”) of potential importance to a given user, b) calculate one or more ranks that indicate the method's estimate of how important the activity is to the user, c) generate one or more proposed changes to the user's electronic lists of activities (“activity list”) to accommodate the identified activity and, d) determine if the proposed changes should be accepted or rejected; 2) if the proposed changes are accepted, apply the proposed changes to the activity lists, and; 3) update the data-sources in response to whether and how the proposed changes were accepted or rejected.

### CROSS-REFERENCE TO RELATED APPLICATIONS

The present application claims the benefit of the filing date of U.S. provisional patent application Ser. No. 61/943,440 filed Feb. 23, 2014, and entitled “Creating optimized shopping lists and shopping trip plans,” the teachings of which are hereby incorporated herein by reference in their entirety. The present application additionally claims the benefit of the filing date of U.S. provisional patent application Ser. No. 61/972,223 filed Mar. 29, 2014, and entitled “Creating Optimized To-Do Lists,” the teachings of which are hereby incorporated herein by reference in their entirety.

### BACKGROUND OF THE INVENTION

1. Field of the Invention

The field of the present invention is the automated management of user activities. Activity management comprises identifying activities that are potentially relevant to a person (“user”) and prioritizing/scheduling those activities using one or more electronic activity lists (e.g., calendars, to-do, lists, etc.) Effective activity management must take into account a wide range of parameters and constraints, such as user parameters (e.g., available time, health, current location, interests, finances, activity history, etc.) and activity parameters (description, duration, location, deadline, cost, etc.) Furthermore, because these parameters change over time, activity management must be performed on a continuous and iterative process. As such, activity management consumes much of a typical user's time, and thus there is a need for automated activity-management solutions.

2. Description of the Related Art

Google Now gives suggestions to the user in the form of cards. The content of these virtual cards is based on either the user's input (e.g., Google Search strings entered by the user) or the user's location. The user then chooses from the list of available cards.

Another related solution is Google's Gmail email application. GMail parses a user's emails for activity information. When a user opens a Gmail message that contains activity information Gmail displays an “Add to calendar” link. This link permits the user to add quickly the proposed activity to their Google Calendar. The major drawback of this technique is that it will only work if the user has a Gmail account.

### SUMMARY OF THE INVENTION

Embodiments of the present invention are iterative methods that: 1) analyze data from one or more electronic data-sources so as to a) identify or generate an activity (“proposed activity”) of potential importance to a given user, b) calculate one or more ranks that indicate the method's estimate of how important the activity is to the user, c) generate one or more proposed changes to the user's electronic list of activities (“activity list”) to accommodate the identified activity and, d) determine if the proposed changes should be accepted or rejected; 2) if the proposed changes are accepted, apply the proposed changes to the activity lists, and; 3) update the data-sources in response to whether and how the proposed changes were accepted or rejected.

### BRIEF DESCRIPTION OF THE DRAWINGS

Other aspects, features, and advantages of the invention will become more fully apparent from the following detailed description, the appended claims, and the accompanying drawings in which like reference numerals identify similar or identical elements.

FIG. 1 is a block diagram of a typical embodiment of the present invention.

FIG. 2 is a flowchart of a process employed by one embodiment of system 100 depicted in FIG. 1.

FIG. 3 is a flowchart of a process employed by one embodiment of module 124 depicted in FIG. 1.

FIG. 4 is a flowchart of a process employed by one embodiment of module 122 depicted in FIG. 1.

FIG. 5 is a flowchart of a process employed by one embodiment of module 126 depicted in FIG. 1.

FIG. 6 is a flowchart of a process employed by one embodiment of module 127 depicted in FIG. 1.

FIG. 7 is a flowchart of a process employed by one embodiment of module 121 depicted in FIG. 1.

FIG. 8 is a flowchart of a process employed by one embodiment of module 123 depicted in FIG. 1.

FIG. 9 is a flowchart of a process employed by one embodiment of module 125 depicted in FIG. 1.

### DETAILED DESCRIPTION

Embodiments of the present invention are methods and systems for the management of a user's activities.

A user's activities (“activities”) are either scheduled or unscheduled. A scheduled activity is an activity that has at a minimum a starting date and time, e.g., an appointment. An unscheduled activity is an activity that has no starting date and time, e.g., a to-do item.

A user's electronic list of activities (“activity list”) might be i) a list of only scheduled activities, e.g., a calendar, ii) a list of only unscheduled activities, e.g., a to-do list, or iii) a list of both scheduled and unscheduled activities. A user may have any number of activity lists.

An activity might comprise sub-activities. For example, a shopping trip can be considered a single activity, but a shopping trip typically comprises purchasing multiple items, e.g., all the items on a shopping list. Therefore, acquiring each item on the shopping list can be considered a separate sub-activity.

Embodiments of the present invention process data from one or more electronic data-sources so as to 1) identify activities (“proposed activities”) of potential importance to the user and, 2) give each proposed activity one or more ranks, e.g., numbers that represents an estimate of how important the proposed activity is to the user. An example of a data-source used in ranking proposed activities is a user profile, i.e., a file that lists topics of potential importance to the user and, for each listed topic, one or more rankings that indicate how important that topic is to the user.

The proposed activities are then checked against the existing activity lists to e.g. detect conflicts, and one or more proposed changes are generated. The proposed changes are either automatically accepted or rejected, or submitted to the user for acceptance/rejection. If accepted, the changes are applied to the activity lists. Then, one or more of the data-sources, e.g., the user profile, is updated to reflect whether the proposed changes were accepted or rejected, which data-sources will be used as input to the next iteration. If, for example, the user rejects a proposed activity relating to tennis, then the ranking for the entry for tennis in the user profile might be adjusted. Therefore, certain embodiments of the present invention form feedback loops where the results of one iteration are used to adjust the processing of the next iteration.

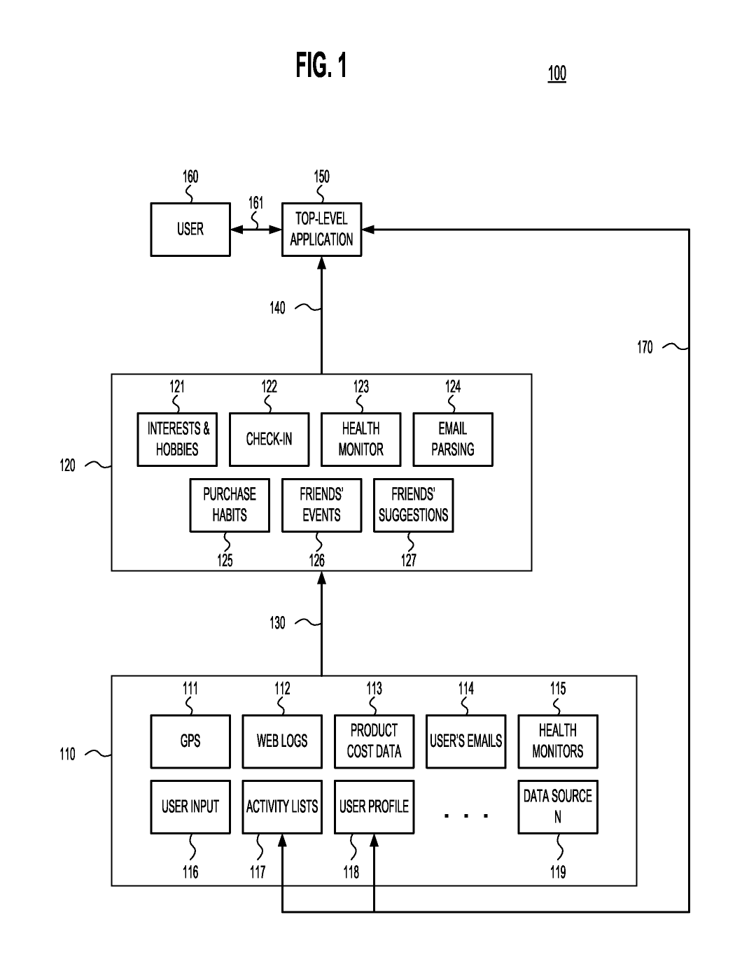

FIG. 1 is a system and data-flow diagram of a typical embodiment of the present invention. System 100 comprises data-sources 110, modules 120, and top-level application 150. In this particular embodiment, data-sources 110 comprises eight specific data-source 111 through 118, although any number of data sources can be accommodated as indicated by data-source N 119. Modules 120 comprise the following modules: User Interests & Hobbies 121, Check-In History 122, Health Monitor 123, Email Parsing 124, Purchase Habits 125, Friends' Events 126, and Friends' Suggestions 127.

Modules 120 process data 130 from data-sources 110 and generate proposed changes 140 that are submitted to top-level application 150. Top-level application 150 exchanges data 161 with the user 160 and exchanges data 170 with activity lists 117 and user profile 118, which are also data-sources.

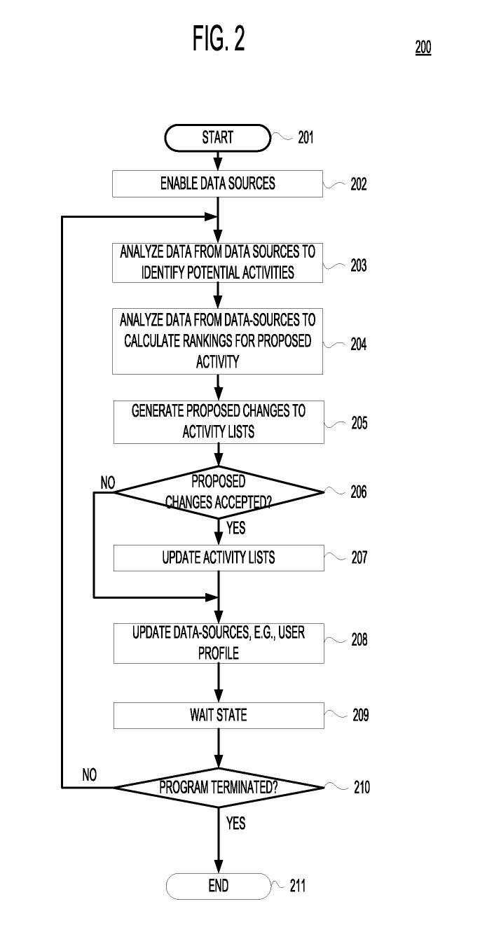

FIG. 2 is a flowchart of a typical process used by system 100. Process 200 starts at step 201 and proceeds to step 202 where various data-sources 110 are enabled. At step 203, modules 120 process the data from data-sources 110 and identify proposed activities, i.e., activities of potential importance to the user. At step 204 modules 120 analyze data from data-sources 110 to calculate one or more rankings for any proposed activities identified in step 203. At step 205, either modules 120 or top-level application 150 convert the proposed activities into proposed changes to one or more activity lists. At step 206, top-level application 150 determines if the proposed changes identified in step 205 should be accepted or rejected. If, at step 206, the proposed changes are rejected, then the process continues to step 208. If, instead, at step 206 the proposed changes are accepted, then at step 207 the accepted changes are applied to the appropriate activity list(s) and the process proceeds to step 208. At step 208, one or more of the data-sources, e.g., a user profile, are updated to reflect the decisions made at step 206. At step 209 the process enters a wait state. The process exits the wait state upon satisfaction of a condition, e.g., a pre-defined amount of time has passed, or new/changed data have been detected. Upon exiting wait state 209, and if the process is not terminated 210, the process will loop back to step 203. If, instead, at step 210 the process has been terminated, process 200 will terminate at step 211.

### Module: Email Parsing

Email-Parsing module 121 parses the user's emails and text messages for activity keywords like time and place. If a keyword is found, the module will continue to look for other activity parameters, e.g., start time, end time, date, and the location of the activity. The activities found by parsing are then sent to the application.

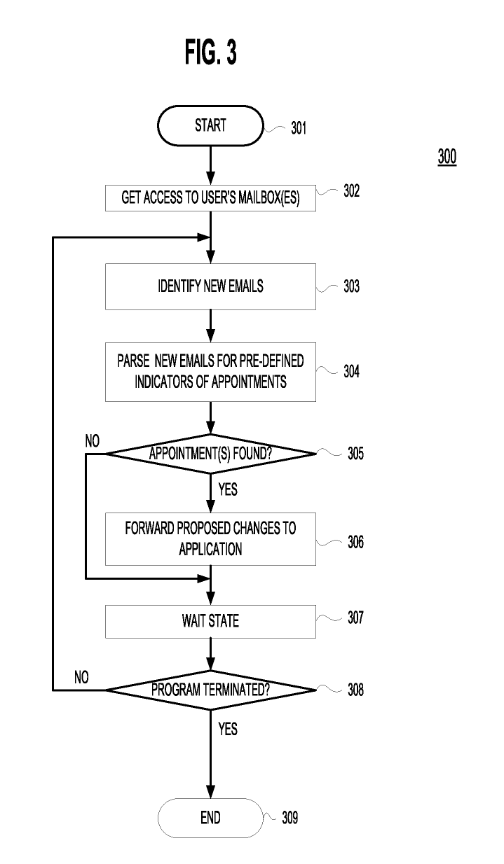

FIG. 3 is a flowchart of process 300 used by one embodiment of Email-Parsing module 124. The process starts at step 301 and proceeds to step 302 where the process gains access to one or more of the user's emailboxes. At step 303, the process identifies new emails since the last time the process was run. At step 304, the process parses through the new emails and searches for indicators of appointment, e.g., keywords like “appointment,” “meeting,” “start time,” etc. If, at step 305, no appointments are identified, then the process enters a wait state 307. If, instead, at step 305 appointments are identified, then at step 306 the process forwards proposed changes to the top-level application and then enters wait state 307. The process exits the wait state upon satisfaction of a condition, e.g., a pre-defined amount of time has passed, or new emails have been detected. Upon exiting wait state 307, and if the process is not terminated 308, the process will loop back to step 303. If, instead, at step 308 the process has been terminated, process 300 will terminate at step 309.

### Module: Check-In History

Check-In History module 122 analyzes data sources 110 so as to construct a historical database (“check-in database”) of the user's location over a given period of time. Such data sources might comprise GPS data, wi-fi location data, Bluetooth data, information from social-networking sites that permit geo-tagging and online check-in, and environmental queues such as temperature and humidity.

Using the check-in database, the Check-In History module can, for a given location, determine e.g., how many times the user has visited that location, how often the user visits that location, and how much time the user spends at a given location. The Check-In History module might then suggest activities based on patterns, i.e., the frequency of the user's visits to particular location. For example, if the user visits a particular hair salon once every month, the application will suggest a recurring monthly activity for inclusion in the user's calendar.

Another use of the Check-In Module is to identify opportunities. For example, if the user's location data indicates that he is near the hair salon and the user is not currently busy, the Check-In module might notify the user of this opportunity to get a haircut.

The Check-In Module might also permit the user to manually indicate locations the user does not want to visit, i.e., a location black list. For example, if the user did not like a particular restaurant, then he can black list it.

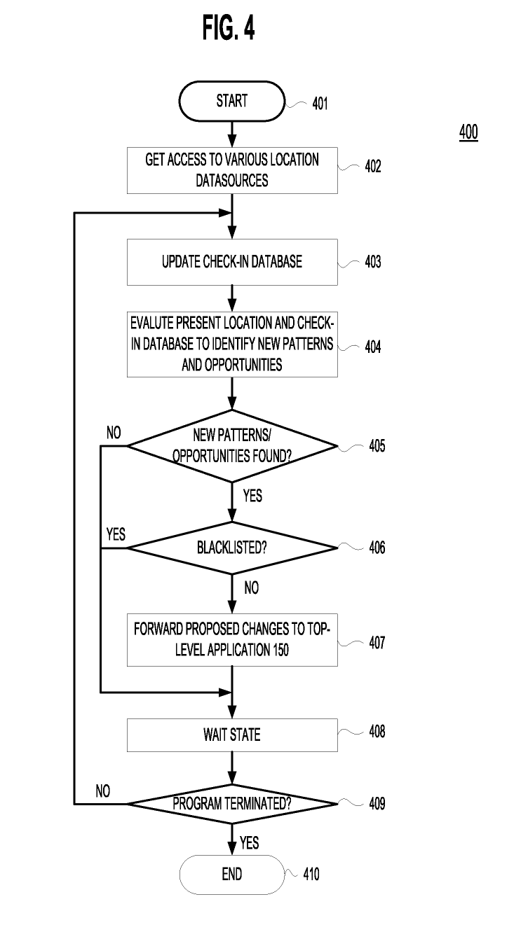

FIG. 4 is a flowchart of process 400 used by one embodiment of Check-In Module 122. The process starts at step 401 and proceeds to step 402 where the process gains access to various location data-sources, e.g., GPS data, wi-fi location data, geo-tagging websites. At step 403, the process updates a check-in database with the user's current location information. At step 404, the process analyzes the check-in database and the user's current location to identify patterns and opportunities. If, at step 405, no new patterns or opportunities are found, then the process proceeds to wait state 408. If, instead, at step 405 the process identifies new patterns or opportunities, then, at step 406, those new patterns and opportunities are compared to a blacklist. If all new patterns and opportunities are blacklisted, then the process enters wait state 408. If, instead, at step 406, any new patterns and opportunities are not discarded, then at step 407 the non-blacklisted patterns and opportunities are submitted to top-level application 150 for processing, and then the process enters wait state 408. The process exits wait state 408 after one or more pre-defined conditions are met, e.g., a pre-defined time period has passed, or there is a change in one of the data-sources, e.g., the user's location has changed. After exiting wait state 408, if the program is not terminated at step 409, then the process loops back to step 403. If, at step 409, the program is terminated, then the process terminates at step 410.

### Module: Friends' Events

Social media tools like Facebook, Twitter, and LinkedIn typically permit a user to enter information about themselves, e.g., name, location, career, hobbies, events, “tweets,” etc. Typically, such tools also permit a first user of the tool to identify a second user of the tool as someone in whom the first user is interested. The exact name given to the second user changes from tool to tool: in LinkedIn they are a “connection,” in Facebook they are a “friend,” and in Twitter they are someone the first user is “following.” For the purposes of this document, the word “friend” shall be used to encompass all of these designations.

Friends' Events module 126 analyzes data from social media tools used by the user to identify proposed activities. Embodiments of the present invention might use any combination of the following factors to calculate the priority of a proposed activity: 1) the number of friends attending the proposed activity; 2) the match between the user's profile and the description of the proposed event; 3) the match between the user's profile and the profiles of the attending friends, and 4) the distance between the event and the user's typical location.

An example of the first factor would be a higher priority given to an event that is being attended by 50 of the user's friends than an event that is being attended by ten of the user's friends. This is based on the assumption that the more friends attend an event, the more likely the event will be of interest to the user.

An example of the second factor would be where the user's profile indicates that the user is an experienced Java programmer. If the description of an event states that the event is for “novice Java programmers,” that event might be given a lower priority than a similar event that is for “experienced Java programmers.”

An example of the third factor would be where the user is an experienced Java programmer, but all of the user's friends attending an event are novice Java programmers. Such an event would be given a lower priority than a similar event where the attending friends are all experienced Java programmers.

An example of the fourth factor would be where an event that is relatively close to the user's typical position is given a higher priority than a similar event that is farther away.

In the example of the second and third factors above, the key information was years of experience or “level.” Other information used in calculating the priority might include the following the user, the user's friends, and the event description: job title (e.g., “System Programmer III,” “Vice President of Finance and Administration”), occupation (“software development,” “fundraising”), skills (e.g., “C++,” “Agile”) and industry (“higher education,” “defense”).

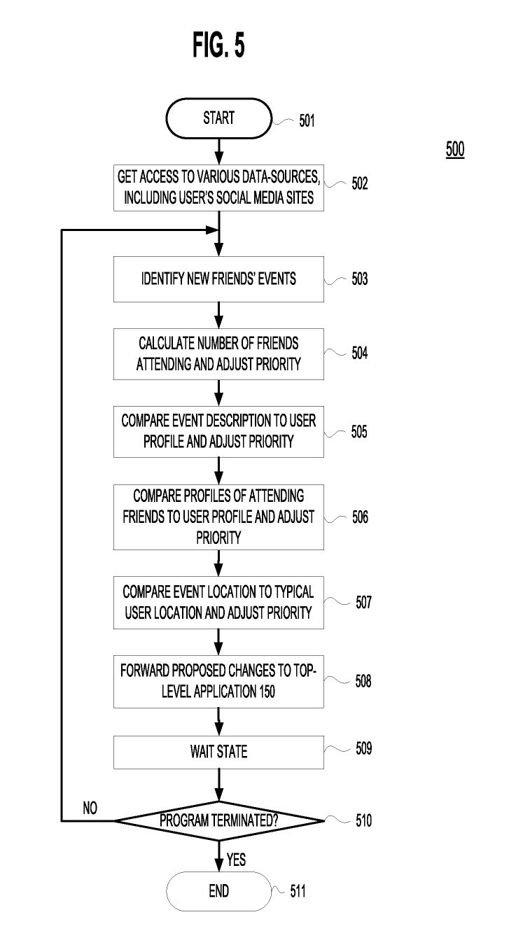

FIG. 5 is a flowchart of a process used by one embodiment of Friends' Events module 126. Process 500 starts at step 501 and proceeds to step 502 where the process gains access to various data-source, including the user's social media sites. At step 503, the process parses information from these data-sources and identifies new events being attended by the user's friends. At step 504, the process adjusts the priorities of the identified events based on the number of friends attending. At step 505, the process compares the descriptions of the events to the user's profile, and adjusts the priority of the events according to the match. At step 506, the process compares the user's profile to the profiles of the attending friends and adjusts the priority of the events according to the match. At step 507, the process adjusts the priorities of the events based on how far the event is from the user's typical location. At step 508, the process forwards the events as proposed activities to top-level application 150 and then enters wait state 509. The process exits wait state 509 after one or more pre-defined conditions are met, e.g., a pre-defined time period has passed, or there is a change in one of the data-sources, e.g., notification that a social media site has changed. After exiting wait state 509, if the program is not terminated at step 510, then the process loops back to step 503. If, at step 510, the program is terminated, then the process terminates at step 511.

### Module: Friends' Suggestions

Friends' Suggestions module 127 analyzes data from data-sources 110 to collect all the suggestions of the user's friends. Unlike Friends' Events module 126, the Friends' Suggestions module does not look solely at events being attended by the user's friends. Instead, Friends' Suggestions module 127 looks at all suggestions from friends, regardless of whether the suggestion is for an event, a product, a vacation destination, etc. The suggestions may come from, e.g., social networking sites or emails to the user from friends.

In one embodiment, the Friends' Suggestion module prioritizes suggestions according to the number of friends making the suggestion: the greater the number of friends suggesting the same thing, the higher the priority. The module then displays to the user all suggestions, or those suggestions whose priority is greater than a predefined threshold, as a suggestion list. If the user indicates that he or she is not interested in a particular suggestion, that suggestion is removed from the suggestion list. If the user indicates that he or she is interested in the suggestion, the invention might submit the suggestion to other modules. For example, if the user is interested in a product suggested by a friend, it might automatically be submitted to the shopping module for inclusion in a shopping list. Similarly, suggested events can be added to the user's calendar and suggested places can be used as an input to the user interest/hobbies module.

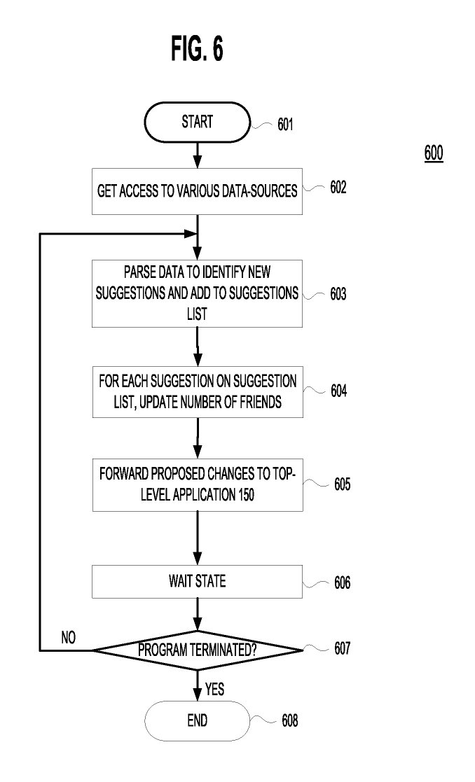

FIG. 6 is a flowchart of a process used by one embodiment of Friends' Suggestions module 127. Process 600 starts at step 601 and proceeds to step 602 where the process gains access to various data-source, including the user's social media sites. At step 603, the process parses information from these data-sources and identifies new suggestions, i.e., suggestions not yet presented to the user, and adds those new suggestions to a suggestion list. At step 604, for each suggestion on the suggestion list the process calculates number of friends making that suggestion. At step 605, the process forwards the events as proposed activities to top-level application 150 and then enters wait state 606. The process exits wait state 606 after one or more pre-defined conditions are met, e.g., a pre-defined time period has passed, or there is a change in one of the data-sources, e.g., a social media site has changed. After exiting wait state 606, if the program is not terminated at step 607, then the process loops back to step 603. If, at step 607, the program is terminated, then the process terminates at step 608.

### Module: User's Interests/Hobbies

User's Interests/Hobbies module 121 analyzes data-source 110 and makes suggestions based on the user's interests and hobbies. The module repeatedly determines the user's interests by analyzing data from various sources including direct input from the user, the user's web browsing history, the user's activity history, and information from the user's profiles on various social networking sites. The module then updates the User Profile with those interests and hobbies. Then the module uses that profile of interests and hobbies to search various data-sources for anything that matches those interests and hobbies in the User Profile, and presents those suggestions to top-level application 150 for presentation to the user or automatic inclusion in one or more activity lists. These suggestions might be for e.g. a product, an event, or a place to visit.

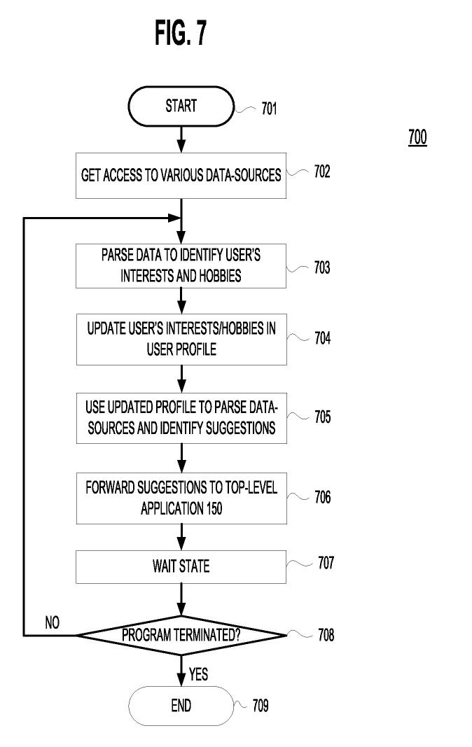

FIG. 7 is a flowchart of a process used by one embodiment of User's Interests/Hobbies module 121. Process 700 starts at step 701 and proceeds to step 702 where the process gains access to various data-sources, including the user's social media sites and the user's profile. At step 703, the process parses information from these data-sources and identifies the user's interests and hobbies. At step 704, the user's profile is updated with the output from step 703. At step 705, the updated user's profile is used to search various data-sources for items of interest, e.g., videos regarding a favored topic of the user, or news about a place that the user likes. At step 706, these items of interest are forwarded to the top-level application 150 as suggestions. The process then enters wait state 707. The process exits wait state 707 after one or more pre-defined conditions are met, e.g., a pre-defined time period has passed, or there is a change in one of the data-sources, e.g., a notification that a social media site has changed. After exiting wait state 707, if the program is not terminated at step 708, then the process loops back to step 703. If, at step 708, the program is terminated, then the process terminates at step 709.

### Module: Health Monitor

Health Monitor module 123 analyzes data from various data-sources regarding the current and historical health condition of the user and identifies suggested changes to the user's activities list in response to this data. The most important of the data-sources is 1) health monitoring devices, e.g., wearable health devices that monitor temperature, heart rate, blood pressure, etc. and 2) the User Health Profile, a subset of the User Profile that contains historical information regarding the user's physical, mental, or emotional health.

Key to understanding the Health Monitor module is the concepts of exertion, recovery, and net exertion.

Exertion measures the physical, mental, or emotional effort required from the user to complete the task in a given time. Examples of high-exertion activities include a 75-mile bike ride (high physical exertion), researching and producing an academic paper (high mental exertion), and attending a deposition (high emotional exertion).

Recovery measures an activity's ability to restore or improve a user's physical, mental, or emotional health. For example, sleep is an activity that requires little or no exertion and improves a user's physical, mental, and emotional health. Another example is the morning jog: while it requires physical exertion, it still might have a recovery effect on the user's mental or emotional health.

The sum of the exertion and recovery factors of all activities within a given time period is the net exertion.

The User Health Profile is a collection of data that might comprise data regarding the user's current physical, mental, and emotional health, e.g., age, weight, heart rate, blood pressure, past medical history, etc. Such data might be acquired via manual user input or data from health-monitoring devices such as a wearable health monitor. Further, the User Health Profile might comprise various thresholds or limits regarding the user's physical, mental, or emotional health, e.g., user-entered data regarding the user's desired level of physical exertion in a given time period, or guidelines acquired from a third party that define maximum exertion thresholds in a given time period.

In one embodiment of the present invention, the scheduling of an activity is decided in part by the exertion of the activity and the User Health Profile. For a 75-mile bicycle ride, the invention might allot more time for an overweight 25-year-old user with hypertension than for a 72-year-old who recently completed a half-marathon, or remove the task from the first user's activity list altogether. Furthermore, the method might dynamically adjust the activity in response to realtime data input. If during the bike ride the user's blood pressure exceeds a predetermined threshold, the method might respond by allotting more time to complete the activity, or suggest abandoning the activity until the user's condition improves.

Another embodiment of the present invention does not consider the exertion/recovery of each activity in isolation, but in conjunction with other activities contained within a time period that contains the activity in question. A 75-mile bicycle ride for anyone might be unwise if that person has not had eight hours of sleep in the last 24 hours, or if it takes place just after running a marathon. Similarly, attending a funeral and a deposition in the same day might be emotionally overtaxing for most people. In response, the method might suggest inserting a high-recovery activity (e.g., sleep, meditation, watching a movie) between the funeral and deposition so as to keep the net exertion below a predetermined threshold.

In yet another embodiment of the present invention, changes in a user's health profile might cause the invention to propose a healthcare-related change to the user's electronic list of activities. For example, if a health-monitoring device detects that the user's blood pressure has exceeded a pre-determined threshold, the invention might propose adding or moving forward a trip to the doctor.

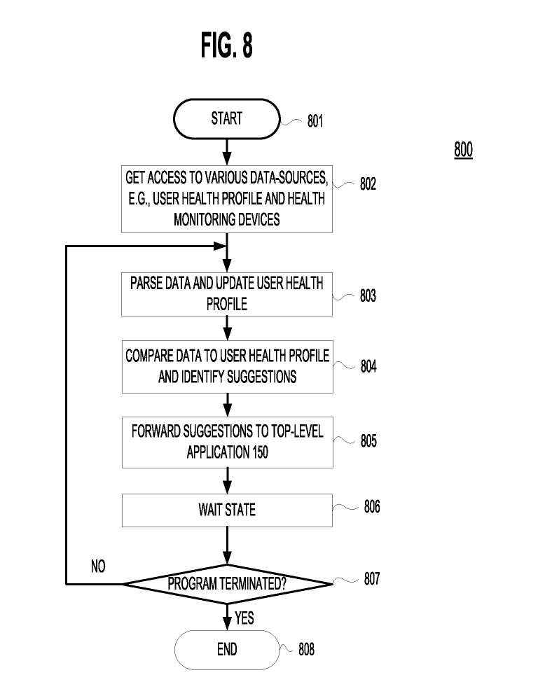

FIG. 8 is a flowchart of a process used by one embodiment of Health Monitor module 123. Process 800 starts at step 801 and proceeds to step 802 where the process gains access to various data-sources, including health monitoring devices and the User Health Profile. At step 703, the process parses information from these data-sources and uses the parsed data to update the User Health Profile. At step 804, the parsed data is compared to the User Health Profile to identify any suggested changes to activities. At step 805, any identified suggestions are forwarded to the top-level application 150 for further processing. The process then enters wait state 806. The process exits wait state 806 after one or more pre-defined conditions are met, e.g., a pre-defined time period has passed, or there is a change in one of the data-sources that passes a preset threshold, e.g., new data from health monitoring devices. After exiting wait state 806, if the program is not terminated at step 807, then the process loops back to step 803. If, at step 807, the program is terminated, then the process terminates at step 808.

### Module: Purchase Habits

The Purchase Habits module manages a user's shopping lists and shopping trips.

Shopping refers to a user's acquisition of goods or services (“items”), e.g., driving to a nearby store to pick up milk and eggs, walking to a salon for a haircut, or ordering one or more items online for delivery at a later date.

A shopping list is a list of items that the user wishes to acquire. A shopping plan is an activity that specifies which items are to be acquired, where they are to be acquired, and when they are to be acquired.

In certain embodiments of the present invention, the Purchase Habits module analyzes prior purchasing history to identify likely items for a shopping list. If, for example, the user purchases milk every time they go to the grocery store, then the Purchase Habits module might automatically add milk to the grocery shopping list.

A user is said to acquire an item when they are able to enjoy the benefits of that item. A user acquires an item from a store when they clear the check-out line. A user acquires an item from an online merchant when the item is delivered to them.

The acquisition of an item might comprise any number of the following: identifying a needed or desired item; finding the best purchase price from among multiple vendors; identifying a location (“acquisition point”), physical or virtual, where the item can be acquired; travel to/from the acquisition point (in the case of physical acquisition points); locating the item in the acquisition point, and; completing the purchase (e.g., standing in the checkout line). Despite this complexity, the goal of an acquisition is clear: to acquire the desired/needed item for the least total acquisition cost to the user.

In another embodiment of the present invention, the total acquisition cost of an item on a shopping list is calculated by the Purchase Habits module and used in creating a shopping plan. The total acquisition cost comprises not only the price of the item, but also the time costs of acquisition and indirect costs. Price is the money the user must pay to the acquisition point to acquire the item, typically comprising sticker price, tax, shipping, etc. Time costs include the cost of the user's time required to complete the acquisition, e.g., researching the item and identifying the best price, travel to/from the acquisition point, time spent locating the item in the store, and time spent waiting at the checkout line. In one embodiment, the invention might rely on data such as the store floorplans to calculate more precisely the time spent gathering the item at the acquisition point. Examples of indirect costs are the gasoline and wear/tear on an automobile used to travel to a physical acquisition point.

In another embodiment of the present invention, urgency is a factor used in the creation of a shopping plan. Urgency refers to how soon the user must acquire an item on a shopping list. If a user must acquire an item in the next four hours, and that item can be acquired from a store three miles away for $100 or online for $50 but with a three-day delivery time, the invention might suggest going with the more expensive choice of the store because of the urgency.

In another embodiment of the present invention, expiration is factor used in the creation of a shopping plan. For example, if the user has a coupon for a desired item, and that coupon expires on date X, then the invention will try to schedule the acquisition of that desired item before date X.

In another embodiment of the present invention, the aggregation of multiple acquisitions into a single shopping trip is a factor used in the scheduling of acquisitions. The aggregation of multiple acquisitions into a single shopping trip can change the total acquisition cost of each item because certain costs (e.g., time costs and indirect costs) might now be divided among multiple items, lowering the total acquisition cost of each item.

In one embodiment of the present invention, the proposed changes are changes to a shopping trip e.g., adding an acquisition activity, deleting an acquisition activity, or modifying the parameters of an acquisition activity. An example of the last would be to add or remove acquisitions to/from a shopping trip in response to changes in the data sources. For example, if a user must visit an acquisition point, then it might make sense to add other desired acquisitions to that shopping trip to amortize time costs and indirect costs. A more detailed example: there is an item that is available for a price of $50 in a store two hours away, and $60 online In this example, it is likely that the time costs and indirect costs of traveling to the store are greater than the additional $10 online, so the decision would be to acquire the item online. However, if the user must travel to or near the store for some other reason, then it might make sense to purchase the item from the store.

Similarly, another embodiment of the present invention might take into account the total amount of time available for a shopping trip, and add/remove items from the shopping list. Yet another embodiment of the present invention might keep track of how fast the user is shopping for items and add/drop shopping items to/from the shopping list in response.

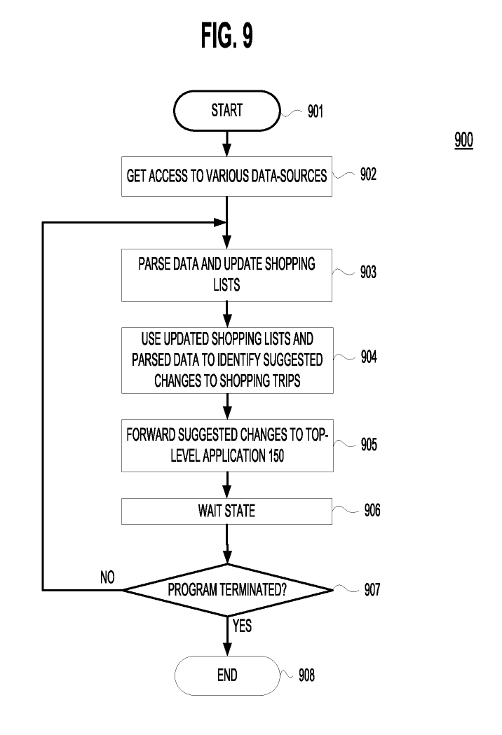

FIG. 9 is a flowchart of a process used by one embodiment of Purchase Habits module 125. Process 900 starts at step 901 and proceeds to step 902 where the process gains access to various data-sources, e.g., user purchase history, purchase price data from various vendors, floorplans of various stores. At step 903, the process parses information from these data-sources and uses the parsed data to update the user's shopping lists. At step 904, the parsed data and the updated shopping lists are analyzed and suggested changes identified. At step 905, any identified suggestions are forwarded to the top-level application 150 for further processing. The process then enters wait state 906. The process exits wait state 906 after one or more pre-defined conditions are met, e.g., a pre-defined time period has passed, or there is a change in one of the data-sources that passes a preset threshold, e.g., new data from health monitoring devices. After exiting wait state 906, if the program is not terminated at step 907, then the process loops back to step 903. If, at step 907, the program is terminated, then the process terminates at step 908.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

We claim:

1. An iterative method that: 1) analyzes data from one or more electronic data-sources so as to a) identify or generate an activity (“proposed activity”) of potential importance to a given user, b) calculate one or more ranks that indicate the method's estimate of how important the activity is to the user, c) generate one or more proposed changes to the user's electronic list of activities (“activity list”) to accommodate the identified activity and, d) determine if the proposed changes should be accepted or rejected; 2) if the proposed changes are accepted, applies the proposed changes to the activity lists, and; 3) updates the data-sources in response to whether and how the proposed changes were accepted or rejected.

2. The invention of claim 1 where the determination of acceptance or rejection includes presenting the proposed activity and/or the proposed changes to the user for the user's response.

3. The invention of claim 1 where the determination of acceptance or rejection does not include presenting the proposed activities and/or proposed changes to the user for the user's response.

4. The invention of claim 1 where the data-sources comprise the activity lists and the history of changes to those lists.

5. The invention of claim 1 where the data-sources comprise interactive user input to the method.

6. The invention of claim 1 where the data-sources comprise user location data from, e.g., a GPS device.

7. The invention of claim 1 where the data-sources comprise user-health data from, e.g., a data from a wearable health monitor.

8. The invention of claim 1 where the data-sources comprise the user's web activity, e.g., pages visited and search strings entered.

9. The invention of claim 1 where the data-sources comprise the user's emails.

10. The invention of claim 1 where the data-sources comprise the user's electronic calendars.

11. The invention of claim 1 where the data-sources comprise the user's purchase history, i.e., an electronic record of the user's purchases.

12. The invention of claim 1 where the data-sources comprise a user profile that contains information about the user.

13. The invention of claim 12 where the user profile contains data regarding topics in which the user is or is not interested and, for each listed topic a ranking that indicates how strongly the user is or is not interested in that given topic or activity.

14. The invention of claim 13 where the updates to the data-sources comprise adding a new topic to the user profile.

15. The invention of claim 13 where the updates to the data-sources comprise modifying the ranking associated with a topic in the user profile.

16. The invention of claim 1 wherein a factor used in generating proposed activities and calculating the ranks of the proposed activity is the effect the proposed activity has on the user's net exertion within a given time period, wherein net exertion is calculated as the sum of the exertion of all activities within the given time period less the sum of all the recovery effects of all activities within the given time period.

17. The invention of claim 16 where a proposed activity is generated when the user-health data crosses a predetermined threshold.

18. The invention of claim 16 where the data-sources comprise user-entered data describing various limits or thresholds on the user's exertion for a given time period.

19. The invention of claim 16 where the data-sources comprise non-user-entered data describing various limits or thresholds on the user's exertion for a given time period.

20. The invention of claim 16 where the factors associated with an activity might include the exertion associated with the activity and the recovery effects associated with the activity.

21. The invention of claim 16 where the exertion is physical exertion.

22. The invention of claim 16 where the exertion is mental exertion.

23. The invention of claim 16 where the exertion is emotional exertion.

24. The invention of claim 1 wherein a factor used in calculating the rank of the proposed activity is the similarity between one or more of the user's characteristics and the characteristics of the proposed activity.

25. The invention of claim 1 wherein a factor used in calculating the rank of the proposed activity is the similarity between one or more of the user's characteristics and the characteristics of a typical participant in the proposed activity as indicated by the description of the proposed activity.

26. The invention of claim 1 wherein the proposed activity is an event being attended by one or more of the user's friends, and a factor used in calculating the rank of the proposed activity is the similarity between the user's characteristics stored in the user profile, and the characteristics of the friend(s) attending the event, which friends' characteristics are recorded in electronic media.

27. The invention of claim 1 wherein the identification of a proposed activity comprises searching the user's email files for symbols or patterns of symbols that are indicative of an event.

28. The invention of claim 1 wherein a factor used in calculating the rank of the proposed activity is the number of times the proposed activity has been mentioned by the user's friends in electronic media.

29. The invention of claim 1 wherein the proposed activities minimize the use of the user's time and money with regards to the acquisition of one or more desired items, i.e., goods or services.

30. The invention of claim 29 where the method identifies items that the user might want to acquire and submits those identified items as proposed changes to one or more shopping lists.

31. The invention of claim 29 where one or more shopping lists are analyzed to generate proposed changes to one or more shopping plans.

32. The invention of claim 31 where a factor in the analysis is the total acquisition cost associated with a particular item.

33. The invention of claim 32 where calculating the total acquisition cost takes into account shipping costs.

34. The invention of claim 32 where calculating the total acquisition cost takes into account indirect costs.

35. The invention of claim 32 wherein one of the electronic data-sources is data regarding the purchase price of a desired good or service from one or more acquisition points.

36. The invention of claim 32 wherein one of the electronic data-sources is data regarding the physical distance between the user's location and one or more physical acquisition points.

37. The invention of claim 32 wherein one of the electronic data-sources is data regarding the precise location of a desired good or service within a physical acquisition point.

38. The invention of claim 37 where the data-source is an API that provides floorplans of physical acquisition points.

39. The invention of claim 32 wherein one of the electronic data-sources is data regarding the value of the user's time.

40. The invention of claim 31 wherein one of the electronic data-sources is data regarding the urgency of the acquisition.

41. The invention of claim 31 wherein one of the electronic data-sources is data regarding the expiration of the ability to acquire a specific good or service at a particular price and/or within a specific time.

42. The invention of claim 30 wherein a good or service is added to the acquisition list because the user has purchased that good or service in the past one or more times.

43. The invention of claim 42 wherein a consumption rate is calculated and that consumption rate is used as a factor.

44. The invention of claim 43 where one of the data-sources is data from a smart appliance, e.g., a smart-fridge.

45. The invention of claim 1 wherein 1) one of the data-sources is a historical record of the user's activity location, i.e., the user's physical location during a particular activity, 2) that historical record is analyzed to identify patterns, and 3) those patterns are used to generate proposed changes.

46. The invention of claim 45 wherein the identified pattern is multiple visits to a particular activity location at regular intervals, and the proposed change is to add, delete, or modify scheduled future activities at the same location.

47. The invention of claim 45 wherein the historical record is compared to the user's current location and, if the user is within a predetermined distance from an activity in the historical record, the proposed activity is to visit that location.

48. The invention of claim 1 wherein the proposed activities are further compared to a list of prohibited activities (e.g., a blacklist) and the proposed activities discarded if they are found on the blacklist.
